(19) United States
(12) Patent Application Publication
(10) Pub. No.: US 2015/0244198 A1
(43) Pub. Date: Aug. 27, 2015

(54) Device for generating renewable electrical power

(71) Applicant: Thomas W. Dale, Snow Hill, MD (US)

(72) Inventor: Thomas W. Dale, Snow Hill, MD (US)

(21) Appl. No.: 13/999,287

(22) Filed: Feb. 6, 2014

(51) Int. Cl. H02J 7/00

(52) U.S. Cl. CPC H02J 7/0052; H02J 7/0068

(57) ABSTRACT

Provided is a self-regenerative charging device. The device includes an inverter configured to receive a direct current (DC) signal from a power supply and provide an alternating current (AC) signal to a load. The charging device also includes a charger having an input terminal configured to receive the AC signal output from the inverter, the charger including one or more output terminal pairs. The power supply includes one or more batteries, each having a battery terminal pair. Each of the one or more charger output terminal pairs is configured for connecting to only one of the battery output terminal pairs.

### CROSS-REFERENCE TO RELATED APPLICATIONS

This application claims the benefit of U.S. Provisional Application No. 61/957,500, entitled Device for Generating Renewable Electrical Power, filed Jul. 5, 2013, which is incorporated herein by reference in its entirety.

### TECHNICAL FIELD

The present invention relates generally to the production of electrical power. More particularly, the present invention relates to electric motors capable of efficiently producing electrical power.

### BACKGROUND OF THE INVENTION

Electricity is the cornerstone of modem society and critical to its survival. More specifically, the economic and social fabric of society are dependent upon the availability and the continued delivery of electricity. Interruptions in electricity delivery (i.e., power outages) from the power grid, especially unanticipated, can have severe, even catastrophic, consequences.

Because electricity cannot be stored in any meaningful way, the only large-scale solution to power outages is backup and temporary electricity supplies. Batteries and power generators are among the most popular backup and temporary electricity supplies. Batteries, regardless of their size and amperage, are limited in the amount of power that can be supplied. Thus, batteries are a suboptimal long term solution to interruptions in electricity delivery.

Power generators represent a more stable mechanism for providing backup power during power outages, or other emergencies, triggered by interruptions in electricity delivery. All power generators, however, require their own energy source and most use fuels, such as gasoline. Thus, the electricity produced by power generators is limited to available you supplies. In most cases, commercial fuel supplies can only be extracted via fuel pumps, such as gasoline pumps. These gasoline pumps, however, require electricity. Therefore, widespread power outages also affect gasoline supplies, ultimately limiting the utility of power generators.

### SUMMARY OF THE EMBODIMENTS

Given the aforementioned deficiencies, a need exists for an electricity delivery device, or power generator, that is not dependent upon the availability of fuel. More particularly, a need exists for self-regenerative renewable power generator.

Under certain circumstances, an embodiment of the present invention includes a self-regenerative charging device. The device includes an inverter configured to receive a direct current (DC) signal from a power supply and provide an alternating current (AC) signal to a load. The charging device also includes a charger having an input terminal configured to receive the AC signal output from the inverter, the charger including one or more output terminal pairs. The power supply includes one or more batteries, each having a battery terminal pair. Each of the one or more charger output terminal pairs is configured for connecting to only one of the battery output terminal pairs.

Further features and advantages, as well as the structure and operation of various embodiments, are described in detail below with reference to the accompanying drawings. The invention is not limited to the specific embodiments described herein. The embodiments are presented for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a high-level block diagram illustration of a power generator constructed in accordance with an embodiment of the present invention.

FIG. 2 is a more detailed illustration of the power generator of FIG. 1.

FIG. 3 is a tabular illustration including exemplary gauges for cables used for connecting to the controller illustrated in FIG. 2.

### DETAILED DESCRIPTION OF THE EMBODIMENTS

While illustrative embodiments are described herein with illustrative embodiments for particular implementations, it should be understood that the invention is not limited thereto. Those skilled in the art with access to the teachings provided herein will recognize additional modifications, applications, and embodiments within the scope thereof, and additional fields in which the lighting systems described herein would be of significant utility.

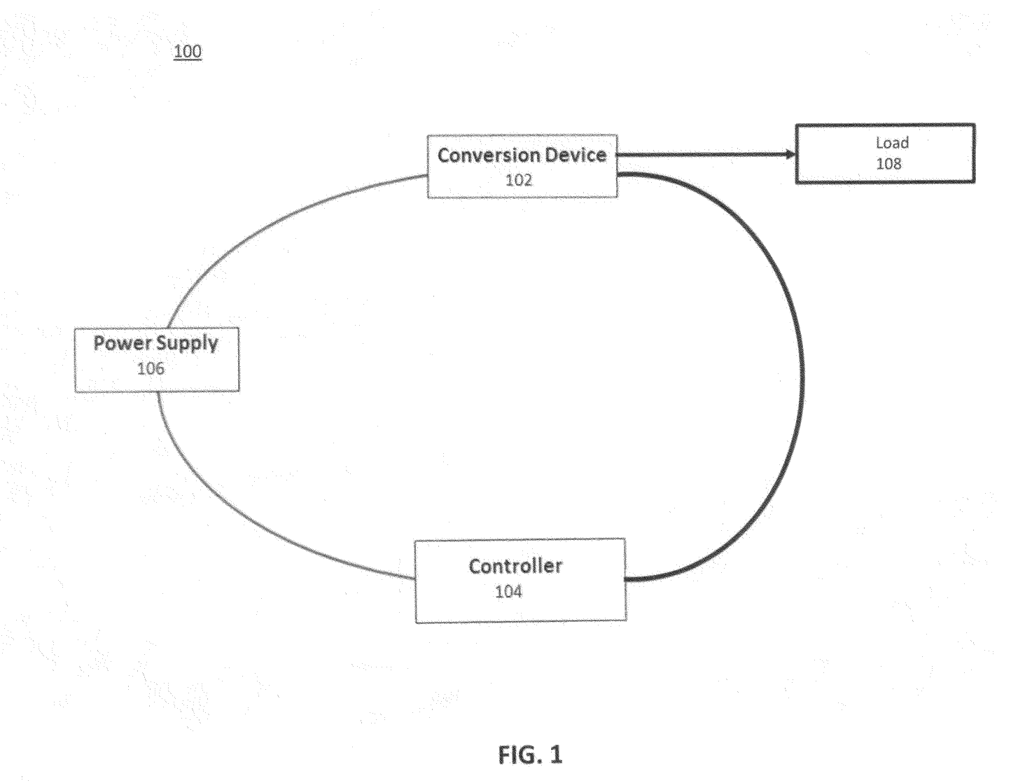

FIG. 1 is a high-level block diagram illustration of a power generator 100 constructed in accordance with an embodiment of the present invention. The power generator 100 is configured to provide continuous self-regenerative AC power to a load, such as one or more electrical devices. More specifically, the power generator 100 is configured to be self-regulating (i.e., self-charging) and will keep a DC power supply, such as batteries, completely charged virtually indefinitely.

In the present embodiment, batteries are the underlying energy source for the power generator 100. The power supply generator 100 automatically shut off when the batteries are fully charged. As the batteries began to discharge, the generator 100 switches on and uses the internally produced AC power to recharge the batteries. This process can continue uninterrupted for days, weeks, or months depending on the specific system requirements and implementation. The continuous self-regenerative AC power process enables the power generator 100 to have a charging efficiency greater than 100%.

The power generator 100 of FIG. 1 includes a conversion device 102. By way of example, and as discussed in additional detail below, the conversion device 102 can be implemented as an inverter. The power generator 100 also includes a controller 104 and a power supply 106. By way of example, and not limitation, the controller 104 can be implemented as a charging device, such as a battery charger.

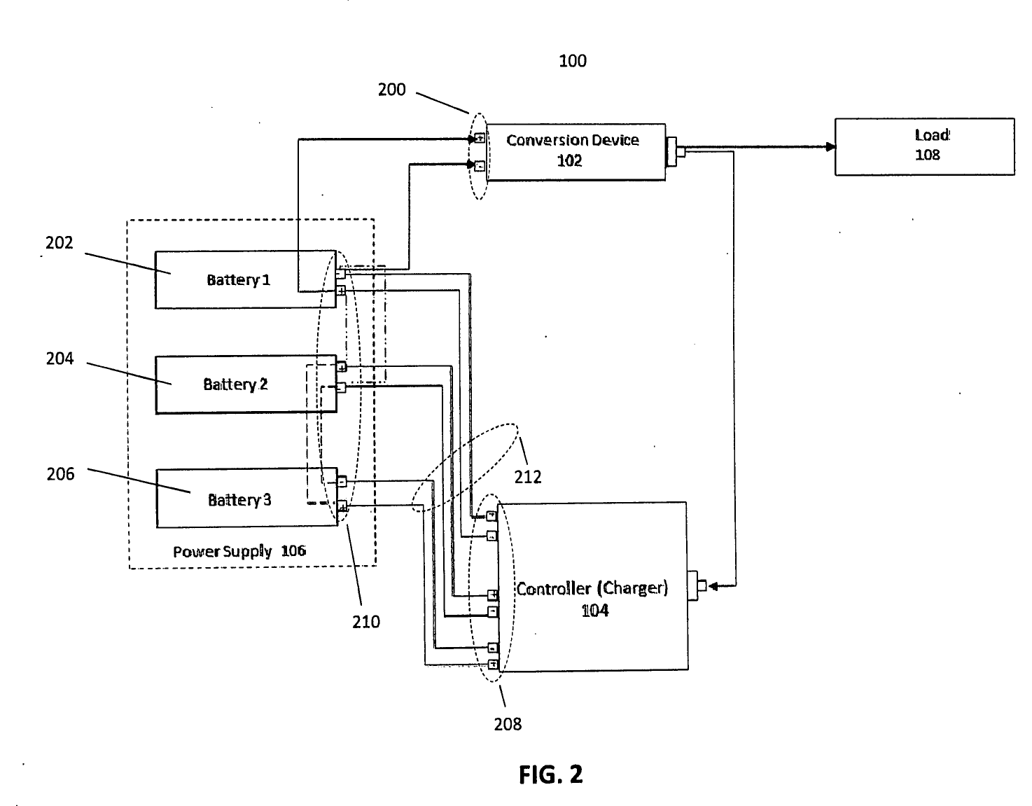

FIG. 2 is a more detailed illustration of the power generator 100 of FIG. 1. In FIG. 2, the conversion device 102 (e.g., an inverter) is configured to receive a DC current from the power supply 106 via positive and negative connection terminals 200. The inverter 102 converts the DC current to an AC current, or voltage.

A voltage rating of the inverter 102 can range, for example, from 12-120V based upon the power needed. In the exemplary power generator 100, the inverter 102 is 12V, with a 35-40 amp rating, and is configured to provide the 120V AC output. The 120V AC, output from the inverter 102, provides power to the load 108. The load can include any electrical device or appliance, such as HVAC systems, industrial machinery, lights, medical devices, and the like. An output of the converter 102 is provided as input to the controller 104.

As depicted, the power supply 106 can include one or more batteries electrically coupled together to produce the DC current flow. In the exemplary illustration of FIG. 2, power supply 106 includes batteries 202, 204, and 206 connected in parallel. The present invention, however, is not limited to three batteries nor limited to parallel connectivity.

As an example, each of the batteries 202-206 can be rated at 12 volts DC and can be connected in parallel to provide sufficient amperage to run the inverter 102. In the exemplary embodiment of FIG. 2, each of the batteries 202-206 is rated at about 23-24 amps. The present invention, however, is not limited to this amperage. Exemplary batteries can include automotive and/or truck batteries, each including about a 625 to 650 cranking amps output. However, as understood by those of skill in the art, other battery types and ratings would be suitable and within the spirit and scope of the present invention.

As depicted in the illustrious embodiment of FIG. 2, a connection terminal of each of the batteries 202-206 is electrically coupled to a respective connection terminal of an adjacent battery. Additionally, positive and negative connection terminals of the battery 202 are coupled to the terminals 200 of the inverter 102, respectively.

As also depicted in FIG. 2, connection terminals of each of the batteries 202-206 are coupled to respective terminals 208 of the controller 104. The controller 104 can be implemented as a charger, such as a modified DC battery charger. In the illustrious embodiment depicted in FIG. 2, the exemplary controller 104 is a converted 120V AC battery charger.

By way of example, and not limitation, a model RS-2 (2×65 Amp Banks) charger with AC input and DC output can be modified for use as the controller 104. The controller 104, or charger, feeds the necessary 12V DC power to charge the power supply 106. The power supply 106 can be comprised of the batteries 202-206.

In FIG. 2, the charger 104 includes multiple terminal pairs (e.g., posts) 208. In the embodiments, the charger 104 desirably includes one terminal pair for connecting to each of the batteries 202-206.

In the present invention, the inventor has discovered that a charger having only a single post experiences difficulty charging the batteries due to the current drain. Thus, the charger 104 desirably includes the individual terminal pairs 208, or charging posts, for connecting to respective terminal pairs 210 on each battery. Additionally, a gauge of cables 212, used to form the electrical connection between the terminals 208 and 210, must be sufficiently suitable for accommodating an electrical flow therebetween.

In the exemplary embodiment of FIG. 2, the exemplary charger 104 is rated at greater than 100 amps. As such, the power generator 100 is configured to provide about a 3000 watts (W) operating output, with a 6000W peak capability to protect against power surges. However, many other types and rated chargers can be used and would be within the spirit and scope of the present invention.

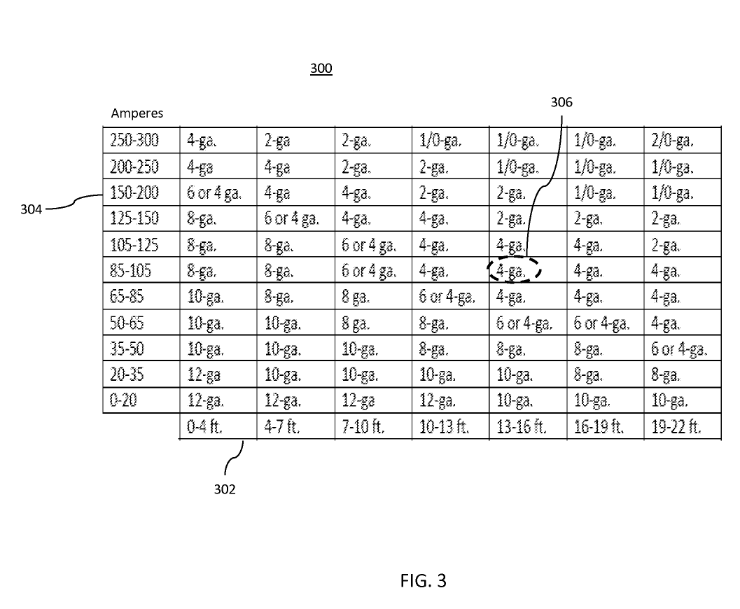

FIG. 3 is a tabular illustration 300 including exemplary gauges for the cables 212 that electrically connect the terminals 208 of the charger 104 to the terminals 210 of the batteries 202-206. In the exemplary embodiments depicted in FIGS. 1 and 2, the gauge of the cables 212 can vary based upon the length of the cables (i.e., a distance between the charger 104 and the power supply 106) and the amperage rating of the charger 104. Although the cables 212 of FIG. 2 are heavy-duty copper cables, other type cables can be used and would be within the spirit and scope of the present invention.

In FIG. 3, for example, a horizontal axis 302 represents a length of the cables 212 and a vertical axis 304 represents an amperage rating of the charger 104. By way of background, typically cables rated at 2 gauge would be sufficient for proper electrical flow between the power supply 106 and the charger 104. Smaller gauge wire—sized 14 to 10 gauge, would typically be cheaper, and may be sufficient in other circumstances. In these other circumstances, however, the cables would desirably satisfy Underwriters Laboratory (UL) safety standards for home utilities and job site applications.

Using the table 300, for example, if the distance between the charger 104 and the power supply 106 is between 13-16 feet and the desired amperage is 100 amps, a desirable gauge 306 would be 4, and so on. Insufficiently thick, or lighter, cables could result in overheating and ultimately sub-optimal performance of the power generator 100. That is, cables having an improper gauge could diminish the charging capability of the charger 106, ultimately reducing the extent to which the batteries 202-206 will remain charged.

### CONCLUSION

Those skilled in the art, particularly in light of the foregoing teachings, may make alternative embodiments, examples, and modifications that would still be encompassed by the technology. Further, it should be understood that the terminology used to describe the technology is intended to be in the nature of words of description rather than of limitation.

Those skilled in the art will also appreciate that various adaptations and modifications of the preferred and alternative embodiments described above can be configured without departing from the scope and spirit of the technology. Therefore, it is to be understood that, within the scope of the appended claims, the invention may be practiced other than as specifically described herein.

We claim:

1. A self-regenerative charging device, comprising:
a conversion device configured to receive a direct current (DC) signal from a power supply and provide an alternating current (AC) signal to a load;
a charger having an input terminal configured to receive the AC signal output from the conversion device, the charger including one or more output terminal pairs; and
wherein the power supply includes one or more terminal pairs; and
wherein each of the one or more charger output terminal pairs is configured for connecting to only one of the battery output terminal pairs.

2. The self-regenerative charging device of claim 1, wherein the power supply includes one or more batteries, each having one or more terminal pairs.

3. The self-regenerative charging device of claim 2, further comprising cables for respectively connecting the one or more charger output terminal pairs to the one or more battery terminal pairs; and
wherein a gauge of the cables of the cables is selectable based upon (i) a distance between the charger and the power supply and (ii) an amperage of the charger.

4. The self-regenerative charging device of claim 2, wherein each of the terminal pairs of one of the batteries is coupled to only one terminal pair of another one of the batteries.

5. The self-regenerative charging device of claim 1, wherein the batteries are connected in parallel.

6. The self-regenerative charging device of claim 1, wherein the conversion device is an inverter.

7. The self-regenerative charging device of claim 6, wherein the AC signal output from the inverter charges the power supply.

8. The self-regenerative charging device of claim 6, wherein the charger has a charging efficiency of greater than 100%.

9. A charging device, comprising:
an inverter configured to receive a direct current (DC) signal from a power supply;
a charger configured to receive an AC signal output from the inverter, the charger including one or more output terminal pairs; and
wherein each of the one or more charger output terminal pairs is configured for connecting to only one output terminal pair of power supply.

10. The charging device of claim 9, wherein the power supply includes one or more batteries.
